(19) United States
(12) Patent Application Publication
(10) Pub. No.: US 2013/0262585 A1
(43) Pub. Date: Oct. 3, 2013

(54) SYSTEM AND METHOD FOR PRESENTATION OF VIDEO STREAMS RELEVANT TO SOCIAL NETWORK USERS

(71) Applicant: MYSPACE LLC, Beverly Hills, CA (US)

(72) Inventors: William Niemeyer, Santa Monica, CA (US); Ward Gross, Santa Monica, CA (US); Colby Palmer, Santa Monica, CA (US)

(73) Assignee: MySpace LLC, Beverly Hills, CA (US)

(21) Appl. No.: 13/854,765

(22) Filed: Apr. 1, 2013

Related U.S. Application Data
(60) Provisional application No. 61/617,779, filed on Mar. 30, 2012.

(51) Int. Cl. H04L 29/06

(52) U.S. Cl. CPC H04L 65/60
USPC 709/204

(57) ABSTRACT

A computer-implemented method, apparatus, system, and computer program product provide the ability to present a media content stream to a social network user. Media content relevant to a user of a social network is compiled in response to user action or user information. The media content is then presented as a video stream to the user.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Provisional Patent Application Ser. No. 61/617,779 filed on Mar. 30, 2012, entitled “SYSTEM AND METHOD FOR PRESENTATION OF VIDEO STREAMS RELEVANT TO SOCIAL NETWORK USERS” by William Niemeyer, Ward Gross, and Colby Palmer, attorneys' docket number 257.38-US-P1;

### BACKGROUND OF THE INVENTION

1. Field of the Invention

The present invention relates generally to the video streams and social media networks, and in particular, to a method, apparatus, and article of manufacture for presenting video streams relevant to social network users.

2. Description of the Related Art

Currently, social networks provide limited opportunities for finding relevant content. Users may generally search for content using a network interface or may manually browse content of associated friends. Also, certain networks provide limited recommendations as to content (e.g., based on a user's profile).

Despite the above, there is a need in the art for an improved system and method for providing relevant content to users.

### SUMMARY OF THE INVENTION

The above described and other problems and disadvantages of the prior art are overcome and alleviated by the present system and method of presenting video streams to social network users. In exemplary embodiments, the social networking system finds and presents continuous streams of video to a user subsequent to or based on an action by a social network user. Such action may be a user search for other users based on criteria, such as users within a certain number of miles from the searching user, gender, age or any other relevant criteria. Such action may also be an initiation of a stream compiled by the system, wherein portions of the stream have been determined to be potentially relevant to a user, for example a stream of the latest video updates from people a user is following or from friends.

In exemplary embodiments, the streamed video can comprise video profiles of users meant to describe themselves. The streamed video may also include video updates or new videos uploaded by people of interest to a user. The streamed video may also include video blogs, photos with accompanying music, among others. In other exemplary embodiments, the video may be playback of music playlists with user generated photographs, for example from concert check-ins, and/or user created fan art.

Thus, exemplary embodiments provide mechanisms for streaming playback of relevant videos for users, providing a continuous stream of “lean back” content that a user can enjoy without further effort, on any desired device, e.g., a computer, a mobile telephone, a television, etc.

The above discussed and other features and advantages of the present invention will be appreciated and understood by those skilled in the art from the following detailed description and drawings.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 illustrates the general structure and interaction within a social media network framework/system in accordance with one or more embodiments of the invention;

FIG. 4 illustrates playback of an exemplary video that has been included in the playback stream represented by a playback bar in accordance with one or more embodiments of the invention;

FIG. 5 illustrates another exemplary hands-off playback (indicated by the shading of a playback bar) of a video stream in accordance with one or more embodiments of the invention;

FIG. 6 illustrates an additional screen shot of a video playing back within the stream but with playback controls exposed in accordance with one or more embodiments of the invention; and

FIG. 7 illustrates the logical flow for presenting a media content stream to a social network user in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention compile and present media content as a video stream to a user of a social network. Such media content may consist of video profiles of users and/or other media content. In this regard, video profiles may provide a rich media viewing experience that focuses on video as a full-screen background with social network meta-data, interaction options, and content recommendations (e.g., songs, videos, etc.) layered over the top. A user can search for people (or their content), and be presented with a full-screen, “lean-back” capable, experience where the user can watch a video of the users representing themselves, or the video may consist of the updates (e.g., “news”) recently received or not yet viewed by the user. The user can further explore the media content (e.g., a viewer subject's profile) and continue to watch uninterrupted playback of the photos, songs, and other videos recommended by the viewer subject. The viewer can easily navigate from person to person, and can then drill down further into a given viewer's content. In addition, branding integration may be achieved by layering on a “skin” that themes the streaming experience for a particular brand/sponsor.

### Hardware Environment

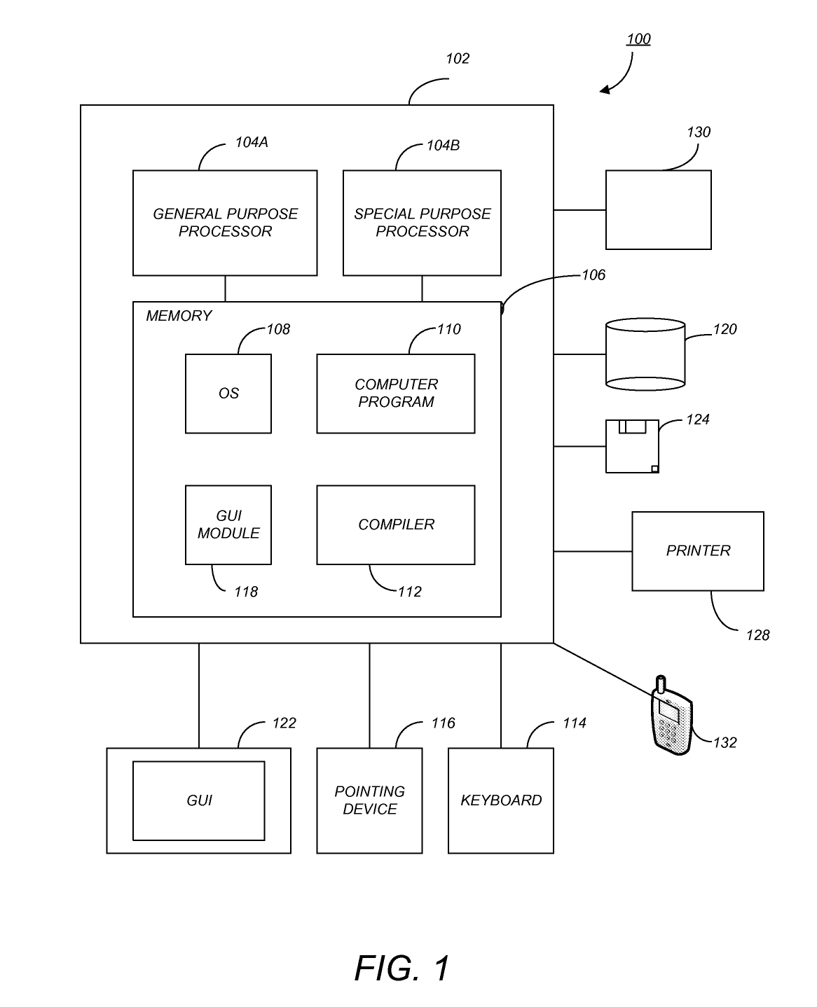

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor 104B is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to implement and/or use the present invention or to load the program of instructions into a memory 106, thus creating a special purpose data structure causing the computer 102 to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

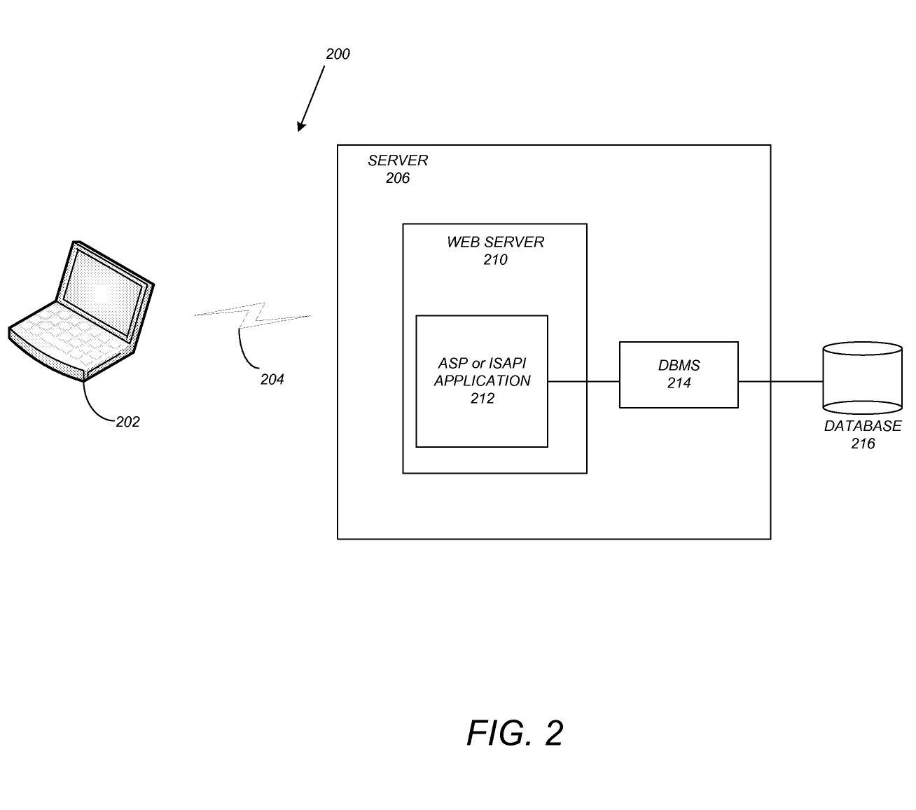

FIG. 2 schematically illustrates a typical distributed computer system 200 using a network 204 to connect client computers 202 to server computers 206. A typical combination of resources may include a network 204 comprising the Internet, LANs (local area networks), WANs (wide area networks), SNA (systems network architecture) networks, or the like, clients 202 that are personal computers or workstations (as set forth in FIG. 1), and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 202 and servers 206 in accordance with embodiments of the invention.

A network 204 such as the Internet connects clients 202 to server computers 206. Network 204 may utilize ethernet, coaxial cable, wireless communications, radio frequency (RF), etc. to connect and provide the communication between clients 202 and servers 206. Clients 202 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 202 may be downloaded from server computer 206 to client computers 202 and installed as a plug-in or ACTIVEX™ control of a web browser. Accordingly, clients 202 may utilize ACTIVEX™ components/component object model (COM) or distributed COM (DCOM) components to provide a user interface on a display of client 202. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 202 instead of communicating/obtaining the information from database 216 across network 204. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 202 and 206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 202 and 206.

### Software Embodiment Overview

Embodiments of the invention are implemented as a software application on a client 202 or server computer 206. Further, as described above, the client 102 or server computer 206 may comprise a thin client device or a portable device that has a multi-touch-based display (i.e., a tablet device), a mobile phone, a gaming system, an IP (internet protocol) enabled television, a television set top box, or other internet enabled device running on various platforms and operating systems. Users may communicate and interact with the software application using a mobile device, client computer 102, portable device, etc.

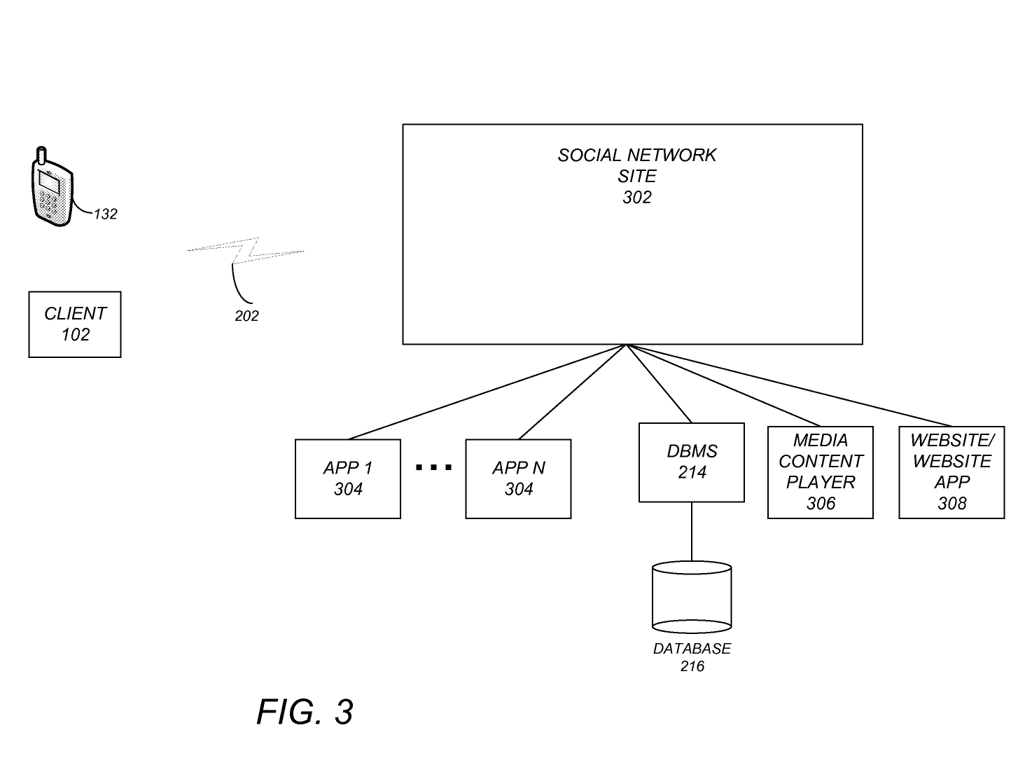

FIG. 3 illustrates the general structure and interaction within an social media network framework/system in accordance with one or more embodiments of the invention. As described above, mobile device 132 and/or client 102 may communicate and interact using a variety of networks 202 with various websites and applications. Mobile application software (commonly referred to as an “app”) may be installed and/or utilized on mobile devices 132 and/or clients 102. Such an app may be downloaded from an application marketplace or online store of applications. The app may be used to provide the functionality herein. In addition, various apps may be used in combination with server side applications to provide the desired functionality. For example, a user 102/132 may install an app on his/her smart phone or tablet device (e.g., iPad™) that is configured to communicate with a social network site 302 and display relevant information on the user's device. Information displayed via the app on the user's device may be pushed to the user's device or pulled from the site 302 depending on the configuration of the app.

On the server side 206, a social network site 302 (e.g., MySpace™ Facebook™, LinkedIn™, Friendster™, Twitter™, Foursquare™, Pinterest™, Instagram™, etc.), may provide an interactive experience to a variety of users 102/132 that access such a social network site 302. Users 102/132 may access social network site 302 via a web browser or via an app on the user's device.

Users 102/132 accessing a social network site 302 may be members of site 302 or may access information without being members. In this regard, access to a site 302 or certain areas of site 302 may be limited to users 102/132 that are members and are logged in to such a site 302. Such a logon may be automatic (e.g., preconfigured using cookies on a web browser or by storing a username/password on the user's device or in the app on the user's device).

Either as part of the social network site 302 or executing separately from the social network site 302, various applications 304-308 may be used to provide additional features to the social network site 302. It may be noted that the description is not limited to the applications depicted in FIG. 3 and additional applications may be used to provide the features described herein. Further, such applications 304-308 may be directly integrated with (e.g., are an integral part of) social network site 302, may interact with each other, and or may interact directly with the user 102/132.

Apps 304 may provide a variety of functionality ranging from games, to facial recognition, to media content discovery, etc. For example, one app 304 may consist of a recommendation engine that is configured to recommend content, events, etc. to a user 102/132 (e.g., based on content gathered and/or stored by social network site 302). DBMS 214 manages all of the data that may be stored in database 216. Media content player 314 enables the ability to view media content uploaded by users 102/132 (or uploaded by a host of site 302). Websites/website apps 308 are websites other than the social network site 302 (e.g., Twitter™, search engines, map-based interactions, etc.) that may use information from social network site 302 or provide additional information based on the social network information.

As described herein, example embodiments of the present invention may include methods and systems of presenting media content streams (e.g., video streams) to social network users 102/132. As used herein, media content includes audio, video, photographs, images, graphics, etc. Media content streams (also referred to as streaming media) refers to multimedia that is constantly received by and presented to an end-user while being delivered by a provider. A client media player 306 (e.g., a content player 306 that is executing on a local device 102/1323) can begin playing the data (such as a movie) before the entire file has been transmitted.

Media content streams may be live streams, on-demand, or any alternative streaming method. Further, as used herein, rather than streaming content, a media player 306 on a client/user device 102/132 may download the media content and play the media content back to the user upon request. Such a configuration may not play content to an end-user while it is being delivered but may store content locally prior to playing. Thus, embodiments of the invention are intended to be utilized in both a streaming and non-streaming implementations. Further, a media player 306 or other device may be configured to retrieve the media content while a user is inactive (e.g., a home computer may retrieve and store media content while a user is away or performing other operations). In other words, while an internet connection is available, media content may be retrieved based on pre-configured attributes. Thereafter, upon a user requesting a view of updated media content, the media player 306 may simply play the retrieved/stored content. Accordingly, a local media player 306 may be configured with the necessary functionality to both retrieve and determine which media content should be displayed to a user 102/132. Alternatively or in addition, such a media player 306 may be configured to deliver/display streamed media content.

In exemplary embodiments, the social networking system/site 302 finds and presents continuous streams of video/media content to a user 102/132 subsequent to or based on an action by a social network user 102/132. Such an action may be a user search for other users based on various criteria, such as users within a certain number of miles from the searching user, gender, age or any other relevant criteria. In other words, the search returns media content from users identified based on the search results. Such an action may also be the initiation of a stream compiled by the system, wherein portions of the stream have been determined to be potentially relevant to a user, for example a stream of the latest video updates from people a user is following or from friends (i.e., those users that a viewing users is “friends” with on a social network site 302).

In view of the above, it may be note that finding relevant content on a social network 302 may be extremely difficult. Further, the ability to express oneself within a prior art social network sites 302 are limited. To overcome such problems, in exemplary embodiments, the streamed media content can comprise video profiles of users meant to describe themselves (e.g., a video recorded by a user that is intended to serve as a video profile for himself/herself). In this regard, a video as a means of self-expression may be a compelling option for users. With the rise in smart-phones and built-in cameras and accessibility to video cutting software, users 102/132 are likely to have the ability to easily create custom video content. Thus, in one or more embodiments of the invention, if a user searches for other users within a particular geographical area, any video profiles for users meeting such criteria may be streamed to the user. The streamed media content may also include video updates or new videos uploaded by people of interest to a user. The streamed media content may also include any type of media content including video blogs, photos with accompanying music, etc.

In additional exemplary embodiments, the media content may be playback of music playlists with user generated photographs (e.g., from concert check-ins), and/or user created fan art.

In view of the above, in one or more embodiments, there are at least two factors that are used to stream media content: (1) an identification of relevant users on a social network (e.g., based on search criteria, friends, etc.); and (2) an identification of which media content is streamed (e.g., from the relevant users) (e.g., video profiles, pictures, music, etc.).

Thus, exemplary embodiments provide mechanisms for streaming playback of relevant media content for users, thereby providing a continuous stream of “lean back” content that a user can enjoy without further effort, on any desired device (e.g., a computer, a mobile telephone, a television, etc.). In this regard, the continuous stream enables a user to enjoy media content in a relaxed environment at the time and location of the user's choice (e.g., come home, site on the couch, and view all of the latest content from a social media site 302 that the user may be interested in).

Users may/may not have the option of determining how and what media content is played. For example, a user may have the option of selecting the content to be played in the media stream. Alternatively, the content that is selected for playback may be automatically determined by the system (e.g., via default selection criteria). In this regard, prior user behavior or selections may be used to define what and how media content is streamed to the user. In yet another embodiment, the content and method for displaying the content may be selected by the system automatically (e.g., via default settings based on various selection criteria); however, the user may then adjust or reconfigure the media content display and selection attributes. Further, a user may be provided with the ability to select what type of content (e.g., all user profiles, pictures, etc.) and/or the user may have the ability to which users the data originates from (e.g., all friends, an identified subset/category of friends, individually selected friends, friends of friends, friends/users having certain attributes [e.g., common education, birth city, etc.], etc.).

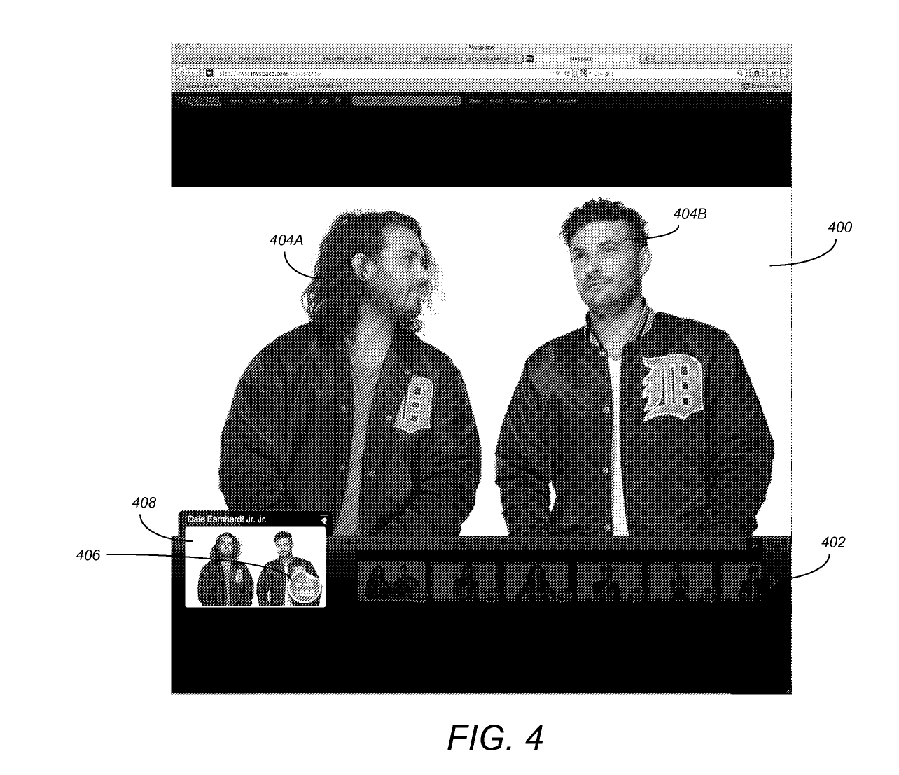

FIG. 4 illustrates playback of an exemplary video 400 that has been included in the playback stream represented by the playback bar 402. Playback bar 402 is shaded during hands-off playback. In addition, a pop-up window 408 is illustrated and provides further information about the current video 400 in the playback bar 402 being viewed. In the exemplary pop-up window 408 illustrated, an image of the subject viewers 404A and 404B appears along with the subject's name (e.g., Dale Earnhardt Jr. Jr.), and a scoring 406 relevant to a calculated “fame” or popularity of the subject or subject video. Accordingly, video 400 includes plural subjects 404A and 404B and shows a fame score 406 in box 408 of “1000.”

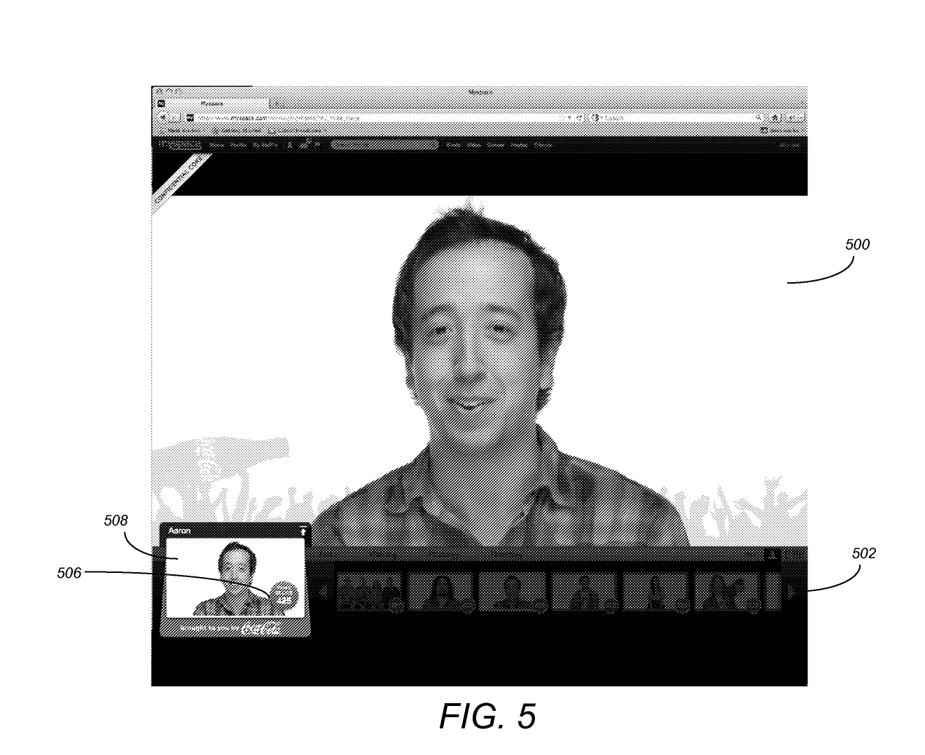

FIG. 5 illustrates another exemplary hands-off playback (indicated by the shading of the playback bar 402) of video 500 in accordance with one or more embodiments of the invention. Pop-up window 508 provides further information about the current video 500 in the playback bar 502 being viewed. In FIG. 5, pop-up window 508 includes an image of the subject viewer, the subject's name (i.e., “Aaron”), an advertisement (e.g., for CocaCola™), and a fame score 506 (e.g., 425). As illustrated, branding integration is achieved by layering on a “skin” that themes the experience for a particular brand (e.g., CocaCola™). Accordingly, the skin may provide a background for displaying a pop-up window 508, a sponsor/advertisement, a color scheme/theme, and/or a consistent interface. As illustrated in FIG. 5, the skin may also carry-over into the background/foreground of the video 500. In this regard, graphics/video/etc. may be composited with the video stream 500. In FIG. 5, the CocaCola™ skin is composited over a video profile and is displayed in both the pop-up window (as part of the skin) as well as over the actual video 500 in a transparent manner. The user may have the ability to determine where and how a skin is displayed as well as the ability to adjust the transparency level of the skin if displayed concurrently with (e.g., composited with) video 500.

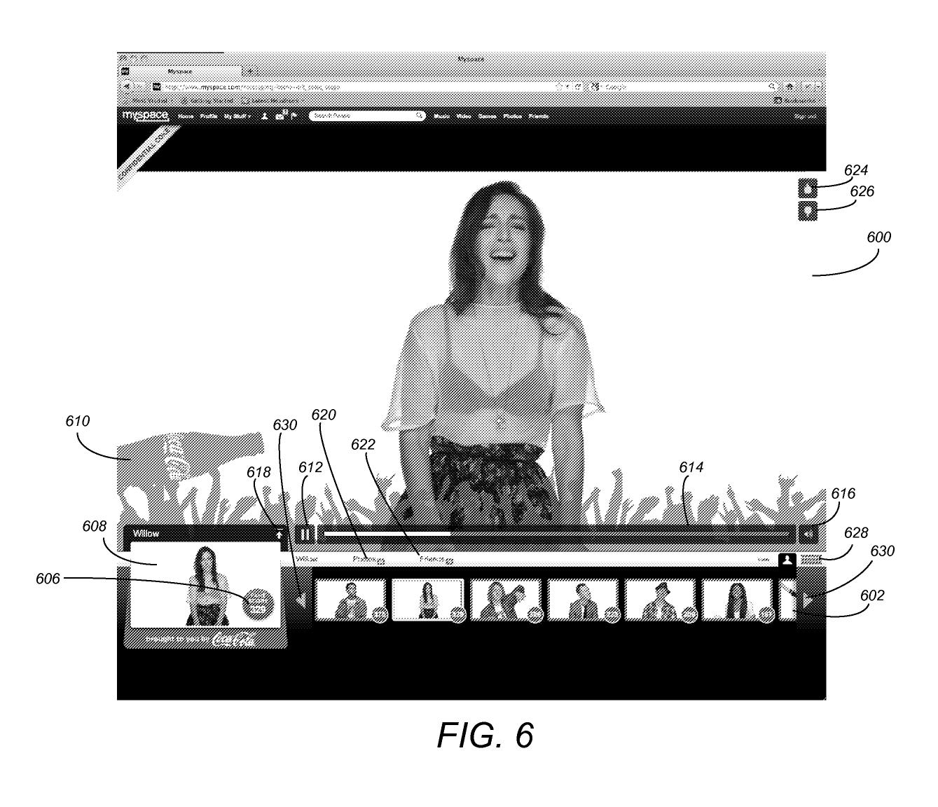

FIG. 6 illustrates an additional screen shot of a video 600 playing back within the stream but with playback controls exposed. Further, the skin that is displayed concurrently with video 600 (i.e., graphics 610) is not as transparent as that of FIG. 5. In this regard, skin 610 is displayed in the foreground in a manner that occludes part of the video 600. Exemplary play controls include a pause button 612, a playback progress bar 614 and sound controls 616. FIG. 6 also shows links to the video subject's profile (at 618), media (e.g., photos) (at 620), and friends (at 622). Like 624 and dislike 626 buttons are also provided.

Different viewing options for viewing the streamed content are illustrated generally at 628, including exemplary bar or matrix viewing of the streamed content. Further, playback bar scrolling functions are provided at 630.

Accordingly, exemplary embodiments described herein provide a system and method for providing relevant streaming content to users. Exemplary presentation of video profiles or other video gives a rich media viewing experience focusing on video as a full screen background with social network meta-data, interaction options and content recommendations layered over the top. In exemplary embodiments, a user can search for people, or their content, and be presented with a full-screen, “lean back” capable, experience (e.g., if content is presented after a search for video profiles, a user can watch series of videos of subjects representing themselves).

Further exemplary embodiments allow a viewing user to explore a viewer's profile and/or to continue to watch uninterrupted playback of the photos, songs or other videos recommended by the viewer. The user can easily navigate from person to person, if desired, and drill down further into a given viewer's content. Further, along the left hand side of a page, a user may have the ability to expand out further information about the person the user is viewing (e.g., via link 618). Similarly, along the right hand side of the page, interaction options may be available for either the person or piece of content the user is looking at. At any point in the viewing process, the user can “lean back” (e.g., refrain from moving a cursor for a designated period of time) and the page controls may fade out (e.g., as illustrated in FIGS. 4 and 5) to provide a distraction free viewing experience.

Thus, the present invention provides presentation of a video stream comprising multiple videos relevant to the user after an action by the user that causes or influences the composition of the video stream. Examples of user activities may include clicking through an advertisement, adding a new friend of a social network, expanding a social network, posting real user activities (e.g., status updates, events, etc), uploading and/or sharing multimedia, sharing photos, sharing video, sharing music, or any other suitable activity. Furthermore, user activities may include clicking, accessing, or sharing content already uploaded to the website. For example, a user may access video, music, or any other suitable material posted by a friend or member of a social network, and thus these activities may be tracked. Additionally, a user may click a shared web-link, URL, or other dynamic content previously posted, and thus these activities may also be tracked. Moreover, any other useful or meaningful user activity including new user registration, increasing/decreasing number of friends, web sales, photo deletion, content removal, etc. may also be tracked. It is also noted that the activities described above are only examples of possible activities to be tracked, and should not be construed as limiting.

### Logical Flow

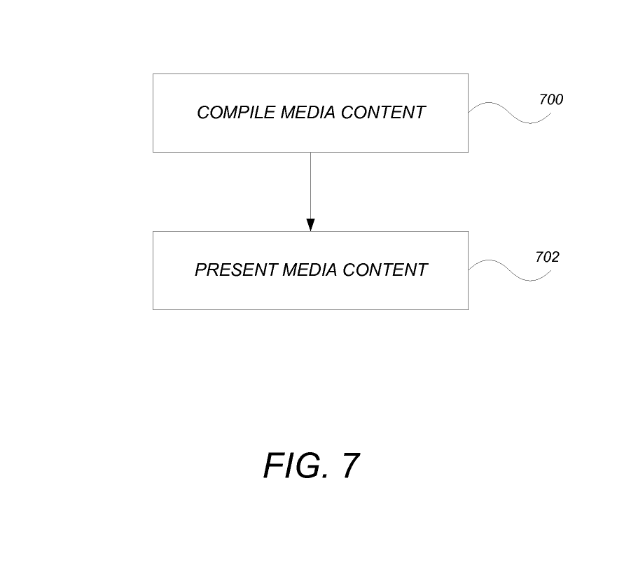

FIG. 7 illustrates the logical flow for presenting a media content stream to a social network user in accordance with one or more embodiments of the invention.

At step 702, media content relevant to a user of a social network is compiled in response to user action or user information. The media content may be user video profiles, user video updates, user video blogs, user media, and/or user music playlists with user generated photographs or user created fan art. In addition, the user action may include a user search for such video profiles. The search may filter results by age, gender, and/or geographical distance from the user. Further, the media content may be compiled relative to a user's friends or persons of interest (e.g., video profiles may be compiled from the user's friends or other persons of interest to the user). The compiling may be performed automatically and/or dynamically (e.g., without any additional user input) according to relevancy of the media content to the user (and/or recency of the content).

At step 704, the compiled media content is presented as a video stream to the user. The presentation as a video stream may also include providing the user with a link to a video subject's profile (e.g., additional information about the user), a link to media content within the video subject's profile (e.g., a link to a song), and/or a link to friends during playback of the media content within the stream. The presentation may also include playback controls that may recede or disappear after a predetermined amount of time with no user activity (e.g., no cursor movement). Further, when presenting the stream, an expandable window (e.g., a pop-up window) may be presented that provided additional information about the content within the stream that is being viewed (e.g., a fame score, user name). Lastly, the presentation may also be displayed within a skin that provides a common/consistent presentation theme/schema for displaying/presenting the media content both in an expandable window and/or in the media content stream itself.

### Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for presenting a media content stream to a social network user, comprising:
compiling media content relevant to a user of a social network in response to user action or user information; and
presenting said media content as a video stream to said user.

2. The computer-implemented method in accordance with claim 1, wherein:
said media content comprises social network users' video profiles; and
said media content is compiled responsive to a user search for video profiles.

3. The computer-implemented method in accordance with claim 2, wherein said user search is filtered by age, gender, and geographical distance from the user.

4. The computer-implemented method in accordance with claim 1, wherein said media content is compiled relative to a user's friends or persons of interest.

5. The computer-implemented method in accordance with claim 4, wherein said media content is automatically compiled according to relevancy of the media content to the user and recency of the content.

6. The computer-implemented method in accordance with claim 1, further comprising providing the user with links to:
a video subject's profile;
media content within the video subject's profile; and
friends during playback of the media content within the stream.

7. The computer-implemented method in accordance with claim 1, wherein said compiled media content comprises:
user video profiles;
user video updates;
user video blogs;
user media; and
user music playlists with user generated photographs or user created fan art.

8. The computer-implemented method in accordance with claim 1, wherein playback controls recede or disappear after a predetermined amount of time with no user activity.

9. The computer-implemented method in accordance with claim 1, further comprising an expandable window providing additional information about the media content within the stream that is being viewed.

10. The computer-implemented method in accordance with claim 1, further comprising presenting the media content based on a skin that provides a consistent predefined presentation schema for presenting the media content.

11. An system for presenting a media content stream to a social network user in computer system comprising:
a client side application executing on a client computer system configured to:
receive user action or user information from a user on a social network;
transmit the user action or user information to a server computer;
receive media content relevant to the user from the server computer; and
present the received media content as a video stream to the user; and
the server computer configured to:
receive the user action or user information from the client side application;
compile the media content relevant to the user; and
transmit the media content relevant to the user to the client side application.

12. The system in accordance with claim 11, wherein:
said media content comprises social network users' video profiles; and
said media content is compiled responsive to a user search for video profiles.

13. The system in accordance with claim 12, wherein said user search is filtered by age, gender, and geographical distance from the user.

14. The system in accordance with claim 11, wherein said media content is compiled relative to a user's friends or persons of interest.

15. The system in accordance with claim 14, wherein said media content is automatically compiled according to relevancy of the media content to the user and recency of the content.

16. The system in accordance with claim 11, wherein the server computer is further configured to provide the user with links to:
a video subject's profile;
media content within the video subject's profile; and
friends during playback of the media content within the stream.

17. The system in accordance with claim 11, wherein said compiled media content comprises:
user video profiles;
user video updates;
user video blogs;
user media; and
user music playlists with user generated photographs or user created fan art.

18. The system in accordance with claim 11, wherein playback controls recede or disappear after a predetermined amount of time with no user activity.

19. The system in accordance with claim 11, wherein the client-side application is further configured to present an expandable window providing additional information about the media content within the stream that is being viewed.

20. The system in accordance with claim 11, wherein the client-side application is further configured to present the media content based on a skin that provides a consistent predefined presentation schema for presenting the media content.
